(19) United States
(12) Patent Application Publication
(10) Pub. No.: US 2023/0289794 A1
(43) Pub. Date: Sep. 14, 2023

(54) USER AUTHENTICATION AT A KIOSK DEVICE

(71) Applicant: Capital One Services, LLC, McLean, VA (US)

(72) Inventors: Brandon Avery GREENE, Middletown, DE (US); Ebrima N. CEESAY, Vienna, VA (US)

(73) Assignee: Capital One Services, LLC, McLean, VA (US)

(21) Appl. No.: 17/693,911

(22) Filed: Mar. 14, 2022

(51) Int. Cl. G06Q 20/40; G06Q 20/18

(52) U.S. Cl. CPC G06Q 20/401; G06Q 20/18

(57) ABSTRACT

Disclosed herein are system, method, and computer program product embodiments for authenticating a user at a kiosk device based on a unique token received by a client device to verify that an identity of the user is authentic, and further permit the user to access an account at the kiosk device. The unique token can be generated responsive to receiving an electronic notification that a card to access the kiosk device associated with the account has been reported lost or stolen. The unique token can be transmitted to the client device associated with the account and the user. The user can be authenticated when the unique token is received from the kiosk device responsive to input data provided by the user. Once authenticated, the user can access the account at the kiosk device.

### BACKGROUND

A kiosk device may include a stand-alone, mounted electronic device that can help users to accomplish tasks at their own pace with an interactive experience. A kiosk device can often be accessible by a user identification or access card and networked with a remote server offsite.

An automated teller machine (ATM) or cash machine is a kiosk device that enables customers of financial institutions to perform financial transactions, such as cash withdrawals, deposits, funds transfers, balance inquiries or account information inquiries, at any time and without the need for direct interaction with bank staff. Customers are typically identified by inserting a plastic ATM card (or some other acceptable payment card) into the ATM, with authentication being by the customer entering a personal identification number (PIN), which must match the PIN stored in the chip on the card (if the card is so equipped), or in the issuing financial institution's database. When an access card such as an ATM card is lost, a user may have difficulty to access a kiosk device to perform desired transactions.

### BRIEF SUMMARY

Disclosed herein are system, apparatus, device, method and/or computer program product embodiments, and/or combinations and sub-combinations thereof for authenticating a user at a kiosk device based on a unique token received by a client device to verify that an identity of the user is authentic, and further permit the user to access an account at the kiosk device. The unique token can be generated responsive to receiving an electronic notification that a card to access the kiosk device associated with the account has been reported lost or stolen. The unique token can be transmitted to the client device associated with the account and the user. The user can be authenticated when the unique token is received from the kiosk device responsive to input data provided by the user. Once authenticated, the user can access the account at the kiosk device.

In some examples, a method is presented for authenticating a user to access an account at a kiosk device. The method can be performed by a system including a cloud server, a client device, and a kiosk device. The method includes receiving, by an account management service of the cloud server, an electronic notification that a card associated with an account accessible through the kiosk device has been reported lost or stolen by a user of the account. Responsive to receiving the electronic notification, the method includes generating, by a token generation service of the cloud server, a unique token associated with the account; and transmitting, by the account management service of the cloud server, the unique token to a client device associated with the account and the user. Afterwards, the method includes receiving, by a control service of the cloud server and from the kiosk device responsive to input data provided by the user, the unique token and an electronic request to access the account at the kiosk device; and authenticating, by an authentication service of the cloud server, the user based on the unique token to verify that an identity of the user is authentic. In response to successfully authenticating the user, the method includes generating, by the control service of the cloud server, an electronic control signal configured to permit the user to access the account at the kiosk device; and transmitting, by the control service of the cloud server, the electronic control signal to the kiosk device.

Descriptions provided in the summary section represent only examples of the embodiments. Other embodiments in the disclosure may provide varying scopes different from the description in the summary. In some examples, systems and computer program products of the disclosed embodiments may include a computer-readable device storing computer instructions for any of the methods disclosed herein or one or more processors configured to read instructions from the computer readable device to perform any of the methods disclosed herein.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIGS. 1A-1B are block diagrams of a system for authenticating a user to access an account at a kiosk device, according to some embodiments.

FIG. 2 illustrates an example process for authenticating a user to access an account at a kiosk device, according to some embodiments.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

A kiosk device, such as an automated teller machine (ATM) or cash machine can help users to accomplish tasks at their own pace with an interactive experience. An ATM can enable customers to perform financial transactions, such as cash withdrawals, deposits, funds transfers, balance inquiries or account information inquiries, at any time and without the need for direct interaction with bank staff. Customers are typically identified by entering a personal identification number (PIN) and an access card or identification card inserted into the ATM, such as an ATM card, a debit card, or a credit card. For descriptions herein a card can be any of the access card or identification card, such as an ATM card, a debit card, a credit card or the like. A kiosk device can be an ATM or any other kiosk device for other services besides financial services. When a card is lost, a user may have difficulty to access a kiosk device to perform desired transactions.

Presently, when a user loses a card to access a kiosk device, the only way the user can access the kiosk device is to receive a replacement card, which may take many days to arrive. Before the replacement card arrives, the user may be impossible to access the kiosk device, e.g., an ATM. Such a long waiting period may cause great inconvenience to the user, leading further to other undesired consequences.

In some embodiments, when an access card is lost or unavailable for any reason, techniques are presented herein for authenticating a user at a kiosk device based on a unique token received by a client device to verify that an identity of the user is authentic. The unique token can be generated responsive to receiving an electronic notification that a card to access the kiosk device associated with the account has been reported lost or stolen. The unique token can be transmitted to the client device associated with the account and the user. The user can be authenticated when the unique token is received from the kiosk device responsive to input data provided by the user. Once authenticated, the user can access the account at the kiosk device. As a result, embodiments herein can offer improved efficiency and convenience to the users so that the users do not need to wait for days to access the kiosk device after the card is lost. In addition, the unique token can be configured to be valid within a predetermined amount of time after receiving the electronic notification. Accordingly, such a unique token that is valid only within a predetermined amount of time can further improve the security of the kiosk device while improving the efficiency and convenience to the users.

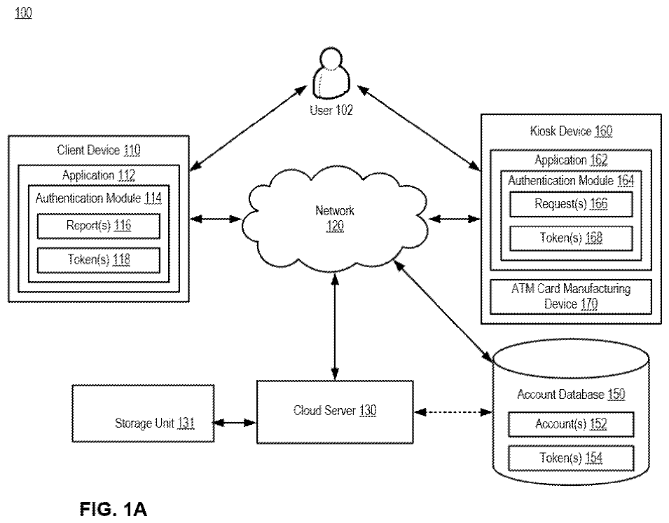

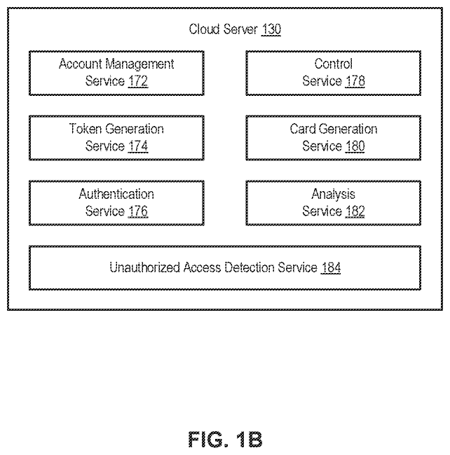

FIGS. 1A-1B are block diagrams of a system 100, according to some embodiments. For example, system 100 can be used for authenticating user 102 to access an account at kiosk device 160. It is to be understood that there may be more or fewer components included in system 100. Further, it is to be understood that one or more of the devices and components within system 100 may include additional and/or varying features from the description below, and may include any devices and components that one having ordinary skill in the art would consider and/or refer as authenticating a user to access an account at a kiosk device.

In some embodiments, system 100 can include a client device 110, kiosk device 160, an account database 150, and a cloud server 130 operatively coupled to each other through a network 120. In some embodiments, client device 110 can include an application 112 operated by a processor and memory of client device 110, where application 112 can include an authentication module 114. Similarly, kiosk device 160 can include an application 162 operated by a processor and memory of kiosk device 160, where application 162 can include an authentication module 164. Furthermore, kiosk device 160 can include an ATM card manufacturing device 170 that can manufacture a physical card such as an ATM card. Account database 150 can include a plurality of accounts 152 and a plurality of tokens 154. Account database 150 can be accessed by user 102 using kiosk device 160. Account database 150 may be a part of kiosk device 160, cloud server 130, or an independent component.

In some embodiments, as shown in FIG. 1B, cloud server 130 can include an account management service 172, a token generation service 174, a control service 178, an authentication service 176, a card generation service 180, an analysis service 182, and an unauthorized access detection service 184. Cloud server 130 may include other hardware or software components, such as processors or memory, e.g., a storage unit 131.

Returning to FIG. 1A, in some embodiments network 120 can be a “computer network” or a “communication network,” which terms are used interchangeably. In some examples, network 120 can include an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

In some embodiments, client device 110 can be a wireless communication device, a smart phone, a laptop, a tablet, a personal assistant, a monitor, a wearable device, an Internet of Thing (IoT) device, a mobile station, a subscriber station, a remote terminal, a wireless terminal, or any other user device. In some other examples, client device 110 can be a desktop workstation, a server, and/or embedded system, communicatively coupled to cloud server 130 by wired lines, or any combination thereof. Client device 110 can also be configured to operate based on a wide variety of wireless communication techniques. These techniques can include, but are not limited to, techniques based on 3rd Generation Partnership Project (3GPP) standards. In some examples, client device 110 can include various components, such as a processor, an operating system, a camera, a storage device coupled to the processor.

In some embodiments, cloud server 130 can include a server device (e.g., a host server, a web server, an application server, etc.), a data center device, or a similar device. Cloud server 130 can include, not shown, a processor, an operating system, server applications operated by the processor, and a storage device coupled to the processor. The processor of cloud server 130 can include one or more central processing units (CPUs), and a programmable device (such as a hardware accelerator or a FPGA). In some embodiments, cloud server 130 can be coupled to storage unit 131, where storage unit 131 is configured to store instructions, and cloud server 130 is configured to process the stored instructions to perform various operations. In some embodiments, storage unit 131 may be integrated and included within cloud server 130.

In some embodiments, account management service 172 can receive an electronic notification that a card associated with an account accessible through kiosk device 160 has been reported lost or stolen by a user of the account, e.g., user 102. For example, user 102 can operate application 112 to generate a report 116 to report an ATM card is lost or stolen. Responsive to receiving the electronic notification, token generation service 174 can generate a unique token 118 associated with the account, and account management service 172 can transmit unique token 118 to client device 110 associated with the account and user 102. In some embodiments, unique token 118 can be transmitted to client device 110 via application 112 by a telephonic message, a short message service (SMS) text message, or an electronic mail (e-mail) message. In addition, unique token 118 can be saved into account database 150 to become token 154 be associated with account 152.

Afterwards, to access kiosk device 160 according to unique token 118, user 102 can provide an input data to kiosk device 160, where the input data can become unique token 168 that can have the same content as unique token 118 if provided by the authentic user 102. In some embodiments, unique token 118 and unique token 168 can be a token of finite length of elements of a keyboard of kiosk device 160. Unique token 118 is referred to be unique so that no two tokens generated by token generation service 174 are the same. Unique token 118 and unique token 168 can be valid within a predetermined amount of time after receiving the electronic notification, e.g., valid within 30 minutes after receiving the electronic notification.

In some embodiments, control service 178 can receive from kiosk device 160, responsive to the input data provided by user 102, unique token 168 and an electronic request 166 to access account 152 at kiosk device 160. Afterwards, authentication service 176 can authenticate user 102 based on unique token 168 to verify that an identity of the user is authentic. Authentication service 176 can verify the identity of user 102 is authentic by checking the received unique token 168 from kiosk device 160 against token 154 associated with account 152 saved in account database 150. In response to successfully authenticating user 102, control service 178 can generate an electronic control signal configured to permit user 102 to access account 152 at kiosk device 160, and further transmit the electronic control signal to kiosk device 160. On the other hand, in response to a unsuccessful authentication, e.g., the received unique token 168 is different from token 154 associated with account 152 saved in account database 150, the unauthorized access detection service 184 can generate a notification to be sent to kiosk device 160 to indicate the input data provided by user 102 to kiosk device 160 is not valid. User 102 can have the option to reenter the input data to try again in case the previous input data has some errors.

In some embodiments, to improve the security protection, instead of having one unique token 118 which can be viewed as a first unique token, a second unique token can be issued as well for improved security protection. In some embodiments, token generation service 174 can generate a second unique token associated with account 152, and account management service 172 can transmit the second unique token to client device 110 associated with account 152 and user 102. Afterwards, user 102 can provide a second input data to kiosk device 160, where the second input data can become a unique token that has the same content as the second unique token.

Similarly, control service 178 can receive, from kiosk device 160 and responsive to the input data provided by user 102, the second unique token and a second electronic request to access the account at kiosk device 160. Afterwards, authentication service 176 can authenticate user 102 based on the first unique token 168 and the second unique token to verify that an identity of the user is authentic. In response to successfully authenticating user 102, control service 178 can generate a second electronic control signal configured to permit user 102 to access the account at kiosk device 160, and further transmit the electronic control signal to kiosk device 160.

In some embodiments, in response to successfully authenticating user 102, control service 178 can generate a second electronic control signal configured to instruct kiosk device 160 to manufacture a physical card by using ATM card manufacturing device 170. In some embodiments, a completely manufactured physical card may be already stored in kiosk device 160, and may simply be distributed using ATM card manufacturing device 170. In some other embodiments, a half completed physical card may be stored in kiosk device 160, and ATM card manufacturing device 170 may updated the half completed physical card to produce the physical card to user 102. Control service 178 can further transmit the second electronic control signal to kiosk device 160.

In some embodiments, in response to successfully authenticating user 102, card generation service 180 can generate a digital card configured to be stored in client device 110 and to permit the user to access the account at the kiosk device. The digital card can be further transmitted from cloud server 130 to client device 110.

In some embodiments, user 102 can provide an input data to kiosk device 160, where the input data may be related to a request for an operation to be performed by kiosk device 160. Responsive to input data provided by user 102, cloud server 130 can receive an electronic request to make a withdrawal from the account. Analysis service 182 can determine whether an amount of the withdrawal is equal to or less than a balance or authorized amount of the account. Control service 178 can generate, in response to determining that the amount of the withdrawal is equal to or less than the balance or authorized amount of the account, a second electronic control signal configured to instruct the kiosk device to permit the withdrawal. Control service 178 can transmit the second electronic control signal to the kiosk device. There may be requests for other operations besides the operation for withdrawal to be performed by kiosk device 160, which are not described herein.

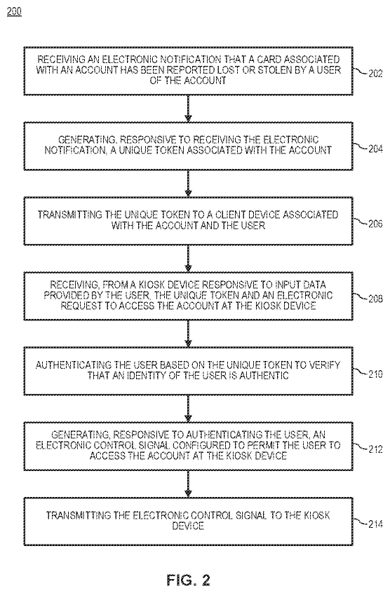

FIG. 2 illustrates an example process 200, according to some embodiments. For example, process 200 may be implemented by various component of cloud server 130. In some embodiments, process 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

In operation 202, account management service 172 can receive an electronic notification that a card associated with an account accessible through kiosk device 160 has been reported lost or stolen by a user of the account, e.g., user 102. For example, user 102 can operate application 112 to generate a report 116 to report an ATM card is lost or stolen.

In operation 204, responsive to receiving the electronic notification, token generation service 174 can generate a unique token 118 associated with the account.

In operation 206, account management service 172 can transmit unique token 118 to client device 110 associated with the account and user 102. In some embodiments, unique token 118 can be transmitted to client device 110 via application 112 by a telephonic message, a short message service (SMS) text message, or an electronic mail (e-mail) message.

In operation 208, control service 178 can receive from kiosk device 160 responsive to the input data provided by user 102, unique token 168 and an electronic request 166 to access the account at kiosk device 160.

In operation 210, authentication service 176 can authenticate user 102 based on received unique token 168 to verify that an identity of the user is authentic.

In operation 212, in response to successfully authenticating user 102, control service 178 can generate an electronic control signal configured to permit user 102 to access the account at kiosk device 160.

In operation 214, control service 178 can further transmit the electronic control signal to kiosk device 160.

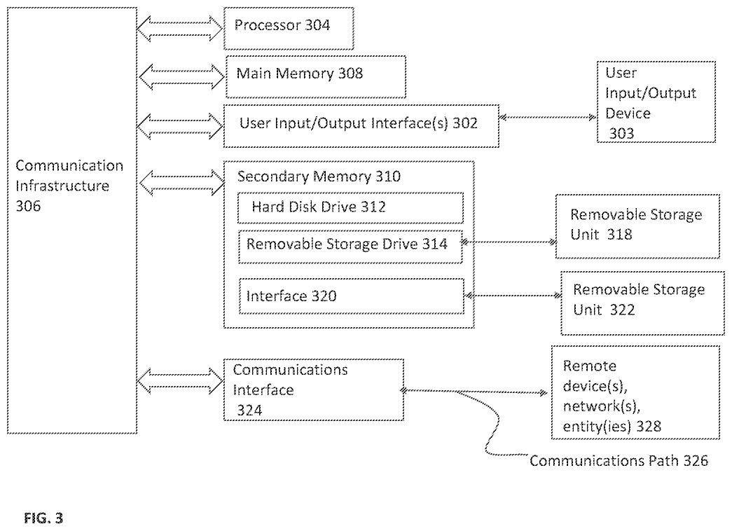

FIG. 3 shows a computer system 300, according to some embodiments. Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof. In some examples, computer system 300 can be used to implement client device 110, kiosk device 160, or cloud server 130 as shown in FIGS. 1A and 1B, or operations shown in FIG. 2. Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein. For example, control logic may cause processor 304 to perform operations shown in FIG. 2.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections may set forth one or more but not all exemplary embodiments of the present description as contemplated by the inventor(s), and thus, are not intended to limit the present description and the appended claims in any way.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A computer-implemented method comprising:
receiving, by an account management service of a cloud server, an electronic notification that a card associated with an account has been reported lost or stolen by a user of the account;
generating, by a token generation service of the cloud server responsive to receiving the electronic notification, a unique token associated with the account;
transmitting, by the account management service of the cloud server, the unique token to a client device associated with the account and the user;
receiving, by a control service of the cloud server and from a kiosk device responsive to input data provided by the user, the unique token and an electronic request to access the account at the kiosk device;
authenticating, by an authentication service of the cloud server, the user based on the unique token to verify that an identity of the user is authentic;
generating, by the control service of the cloud server and in response to authenticating the user, an electronic control signal configured to permit the user to access the account at the kiosk device; and
transmitting, by the control service of the cloud server, the electronic control signal to the kiosk device.

2. The computer-implemented method of claim 1, wherein:
the unique token is a first unique token;
the input data is first input data; and
the computer-implemented method further comprises:
generating, by the token generation service of the cloud server and responsive to receiving the first unique token from the kiosk device, a second unique token associated with the account;
transmitting, by the account management service of the cloud server, the second unique token to the client device;
receiving, by the control service of the cloud server and from the kiosk device responsive to second input data provided by the user, the second unique token; and
authenticating, by the authentication service of the cloud server, the account based on the first unique token and the second unique token to verify that the identity of the user is authentic.

3. The computer-implemented method of claim 1, further comprising:
generating, by a card generation service of the cloud server and in response to authenticating the user, a digital card configured to be stored in the client device and to permit the user to access the account at the kiosk device; and
transmitting, by the account management service of the cloud server, the digital card to the client device.

4. The computer-implemented method of claim 1, wherein:
the input data is first input data;
the electronic request is a first electronic request;
the electronic control signal is a first electronic control signal; and
the computer-implemented method further comprises:
receiving, by the control service of the cloud server and from the kiosk device responsive to second input data provided by the user, a second electronic request to manufacture a physical card;
generating, by a card generation service of the cloud server, a second electronic control signal configured to instruct the kiosk device to manufacture the physical card; and
transmitting, by the control service of the cloud server, the second electronic control signal to the kiosk device.

5. The computer-implemented method of claim 1, wherein the transmitting the unique token to the client device comprises:
transmitting, by the account management service of the cloud server, the unique token to the client device via an application installed on the client device, a telephonic message, a short message service (SMS) text message, or an electronic mail (e-mail) message.

6. The computer-implemented method of claim 1, wherein:
the electronic request is a first electronic request;
the electronic control signal is a first electronic control signal; and
the computer-implemented method further comprises:
receiving, by the control service of the cloud server and from the kiosk device responsive to second input data provided by the user, a second electronic request to make a withdrawal from the account;
determining, by an analysis service of the cloud server, whether an amount of the withdrawal is equal to or less than a balance or authorized amount of the account;
generating, by the control service of the cloud server and in response to determining that the amount of the withdrawal is equal to or less than the balance or authorized amount of the account, a second electronic control signal configured to instruct the kiosk device to permit the withdrawal; and
transmitting, by the control service of the cloud server, the second electronic control signal to the kiosk device.

7. The computer-implemented method of claim 1, wherein the unique token is configured to be valid within a predetermined amount of time after receiving the electronic notification.

8. A non-transitory computer readable medium including instructions for causing a processor to perform operations comprising:
receiving an electronic notification that a card associated with an account has been reported lost or stolen by a user of the account;
generating, responsive to receiving the electronic notification, a unique token associated with the account;
transmitting the unique token to a client device associated with the account and the user;
receiving, from a kiosk device responsive to input data provided by the user, the unique token and an electronic request to access the account at the kiosk device;
authenticating the user based on the unique token to verify that an identity of the user is authentic;
generating, responsive to authenticating the user, an electronic control signal configured to permit the user to access the account at the kiosk device; and
transmitting the electronic control signal to the kiosk device.

9. The non-transitory computer readable medium of claim 8, wherein:
the unique token is a first unique token;
the input data is first input data; and
the operations further comprise:
generating, responsive to receiving the first unique token from the kiosk device, a second unique token associated with the account;
transmitting the second unique token to the client device;
receiving, from the kiosk device responsive to second input data provided by the user, the second unique token; and
authenticating the user based on the first unique token and the second unique token to verify that the identity of the user is authentic.

10. The non-transitory computer readable medium of claim 8, wherein the operations further comprise:
generating, in response to authenticating the user, a digital card configured to be stored in the client device and to permit the user to access the account at the kiosk device; and
transmitting the digital card to the client device.

11. The non-transitory computer readable medium of claim 8, wherein:
the input data is first input data;
the electronic request is a first electronic request;
the electronic control signal is a first electronic control signal; and
the operations further comprise:
receiving, from the kiosk device responsive to second input data provided by the user, a second electronic request to manufacture a physical card;
generating a second electronic control signal configured to instruct the kiosk device to manufacture the physical card; and
transmitting the second electronic control signal to the kiosk device.

12. The non-transitory computer readable medium of claim 8, wherein to perform the transmitting the unique token to the client device, the operations further comprise:
transmitting the unique token to the client device via an application installed on the client device, a telephonic message, a short message service (SMS) text message, or an electronic mail (e-mail) message.

13. The non-transitory computer readable medium of claim 8, wherein:
the input data is first input data;
the electronic request is a first electronic request;
the electronic control signal is a first electronic control signal; and
the operations further comprise:
receiving, from the kiosk device responsive to second input data provided by the user, a second electronic request to make a withdrawal from the account;
determining whether an amount of the withdrawal is equal to or less than a balance or authorized amount of the account;
generating, in response to determining that the amount of the withdrawal is equal to or less than the balance or authorized amount of the account, a second electronic control signal configured to instruct the kiosk device to permit the withdrawal; and
transmitting the second electronic control signal to the kiosk device.

14. The non-transitory computer readable medium of claim 8, wherein the unique token is configured to be valid within a predetermined amount of time after receiving the electronic notification.

15. A computing system comprising:
a storage unit configured to store instructions;
a cloud server coupled to the storage unit and configured to process the stored instructions to perform operations comprising:
receiving an electronic notification that a card associated with an account has been reported lost or stolen by a user of the account;
generating, responsive to receiving the electronic notification, a unique token associated with the account;
transmitting the unique token to a client device associated with the account and the user;
receiving, from a kiosk device responsive to input data provided by the user, the unique token and an electronic request to access the account at the kiosk device;
authenticating the user based on the unique token to verify that an identity of the user is authentic;
generating, in response to authenticating the user, an electronic control signal configured to permit the user to access the account at the kiosk device; and
transmitting the electronic control signal to the kiosk device.

16. The computing system of claim 15, wherein:
the unique token is a first unique token;
the input data is first input data; and
the operations further comprise:
generating, responsive to receiving the first unique token from the kiosk device, a second unique token associated with the account;
transmitting the second unique token to the client device;
receiving, from the kiosk device responsive to second input data provided by the user, the second unique token; and
authenticating the user based on the first unique token and the second unique token to verify that the identity of the user is authentic.

17. The computing system of claim 15, wherein the operations further comprise:
generating, in response to authenticating the user, a digital card configured to be stored in the client device and to permit the user to access the account at the kiosk device; and
transmitting the digital card to the client device.

18. The computing system of claim 15, wherein:
the input data is first input data;
the electronic request is a first electronic request;
the electronic control signal is a first electronic control signal; and
the operations further comprise:
receiving, from the kiosk device responsive to second input data provided by the user, a second electronic request to manufacture a physical card;
generating a second electronic control signal configured to instruct the kiosk device to manufacture the physical card; and
transmitting the second electronic control signal to the kiosk device.

19. The computing system of claim 15, wherein to perform the transmitting the unique token to the client device, the operations further comprise:
transmitting the unique token to the client device via an application installed on the client device, a telephonic message, a short message service (SMS) text message, or an electronic mail (e-mail) message.

20. The computing system of claim 15, wherein:
the input data is first input data;
the electronic request is a first electronic request;
the electronic control signal is a first electronic control signal; and
the operations further comprise:
receiving, from the kiosk device responsive to second input data provided by the user, a second electronic request to make a withdrawal from the account;
determining whether an amount of the withdrawal is equal to or less than a balance or authorized amount of the account;
generating, in response to determining that the amount of the withdrawal is equal to or less than the balance or authorized amount of the account, a second electronic control signal configured to instruct the kiosk device to permit the withdrawal; and
transmitting the second electronic control signal to the kiosk device.
